(19) United States
(12) Patent Application Publication
(10) Pub. No.: US 2005/0160451 A1
(43) Pub. Date: Jul. 21, 2005

(54) Home message system

(75) Inventors: Atul Batra, Lake Forest, CA (US); Pavel Houda, Laguna Hills, CA (US)

Correspondence Address: ORRICK, HERRINGTON & SUTCLIFFE, LLP, 4 PARK PLAZA, SUITE 1600, IRVINE, CA, 92614-2558, US

(73) Assignee: Mitsubishi Digital Electronics America, Inc.

(21) Appl. No.: 10/759,578

(22) Filed: Jan. 16, 2004

(51) Int. Cl. H04N 5/445; H04N 7/173; G06F 13/00; G06F 3/00

(52) U.S. Cl. 725/37; 725/105; 725/112

(57) ABSTRACT

Systems and methods are provided that enhance the utility of a household's TV to facilitate communication between members of the household through a central messaging system. The messaging system includes a TV and a remote control with a touch sensitive panel area on which a user can stroke characters or sketches using a stylus, finger and the like. The remote control is capable of performing character recognition if necessary, and transmitting the characters and/or simple sketches over an IR beam to the TV. The TV then uses its OSD graphical control system to display the characters and sketches. In operation, an operator is able to retrieve and/or draft messages. Once retrieved, the messages can be replied to, stored in non-volatile memory or erased.

### FIELD OF THE INVENTION

The invention relates generally to messaging systems and more particularly to systems and methods that enhance the utility of a television (TV) and remote control to facilitate communications between members of the same household.

### BACKGROUND INFORMATION

Typical household messaging systems include scraps of loose paper and miscellaneous pens and pencils, dry erase and/or cork boards, telephone answering machines, and the like. Whether it's a lack of paper, a dry pen, a broken pencil point, a full answering machine or a full dry erase board, the taking, leaving and receiving of messages is often fraught with frustration in most households.

Thus, it would be desirable to provide a system and method that facilitates communication between members of the household through an improved messaging system.

### SUMMARY

The present invention is directed to systems and methods that enhance the utility of a household's TV to facilitate communication between members of the household through a central messaging system. In a preferred embodiment, a messaging system in accordance with the present invention comprises a TV and a remote control with a touch sensitive panel area on which a user can stroke characters or sketches using a stylus, finger and the like. The remote control is capable of performing character recognition if necessary, and transmitting the characters and/or simple sketches over an IR beam to the TV. The TV then uses its OSD graphical control system to display the characters and sketches.

The remote control is capable of operating in “type”, “character” or “sketch” modes to enter messages. In “type” mode, letters, numbers and symbols can be entered using the keypad on the remote control, while in “character” mode the remote control recognizes characters sketched or stroked on the touch sensitive panel. In “sketch” mode, the remote control enables the entry of simple sketches as part of the transmitted message.

In operation, an operator using the remote control brings up a message board onto the screen of the TV and preferably logs on as a guest or specific system user. Once logged on, the operator is able to retrieve and/or draft messages. Once retrieved, the messages can be replied to, stored in non-volatile memory or erased.

Other systems, methods, features and advantages of the invention will be or will become apparent to one with skill in the art upon examination of the following figures and detailed description.

### BRIEF DESCRIPTION OF THE FIGURES

The details of the invention, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1A depicts a schematic of a TV messaging system in accordance with the present invention.

FIG. 1B depicts a perspective view of a TV messaging system in accordance with the present invention.

FIG. 2 depicts a plan view of a TV remote control in accordance with the present invention.

FIG. 3 depicts a schematic showing control system details of the remote control shown in FIG. 2.

FIG. 4 depicts a flow chart illustrating a messaging process in accordance with the present invention.

FIGS. 5A through 8 depict message board screens.

### DETAILED DESCRIPTION

The systems and methods described herein enhance the utility of a household's TV to facilitate communication between members of the household through a centralized messaging system. More particularly, the system of the present invention preferably includes a remote with a touch sensitive pad upon which characters and simple sketches are stroked or sketched. The TV then uses its OSD graphical control system to display the characters and/or sketches in the form of a message on the screen of the TV. The messages can be sent to individual user mailboxes or a public message mailbox. Once retrieved, the messages can be replied to and stored or deleted.

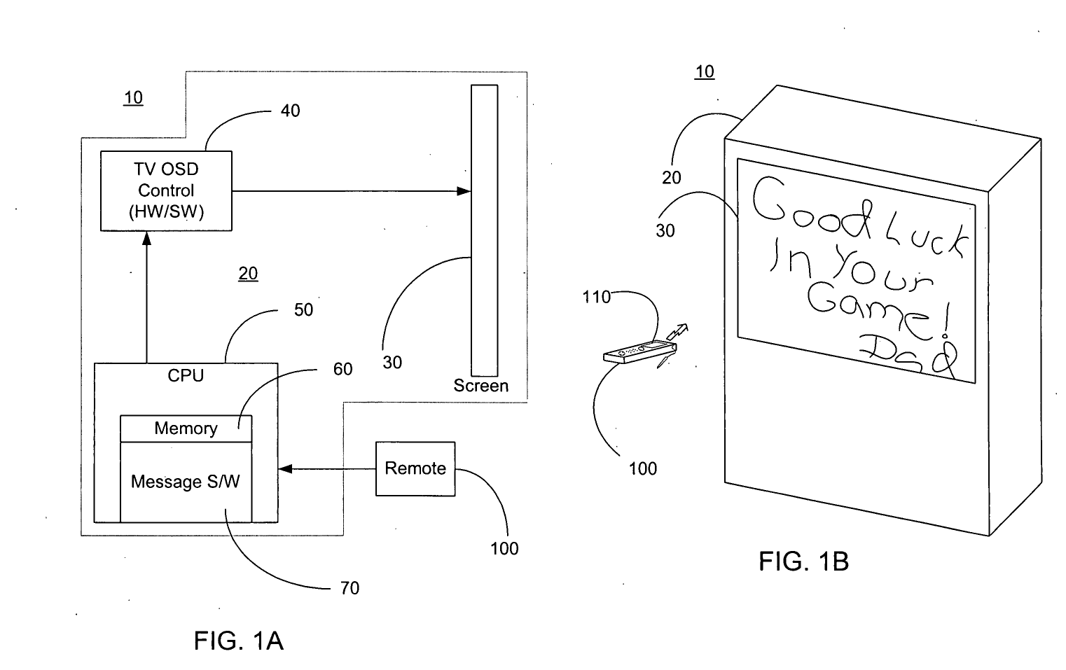

Referring in detail to the figures, a messaging system 10 in accordance with the present invention is depicted in FIGS. 1A and 1B to include a remote control 100 and a TV 20. The remote control 100, which is preferably an IR based controller but may be a RF, blue tooth or the like controller, preferably includes a touch sensitive pad area 110. The TV 20, which may be a picture tube TV, a CRT PTV, a LCOS TV, a DLP PTV, a LCD TV or the like, preferably includes a central processing unit (CPU) or microprocessor 50, which is in communication with the remote control 100 through an IR signal sensor and other hardware (not shown), an OSD control coupled to the microprocessor 50, and a screen 30 coupled to the OSD control 40. The TV 20 also preferably includes non-volatile memory 60 in which messaging software 70 in accordance with the present invention is stored. The microprocessor 50, which runs the messaging software 70, in conjunction with the OSD control 40 causes the characters and sketches received from the remote control 100 to be displayed on the screen 30 and further manipulated by sending the displayed message to a mailbox, discarding or erasing the message, and replying to and/or storing the message.

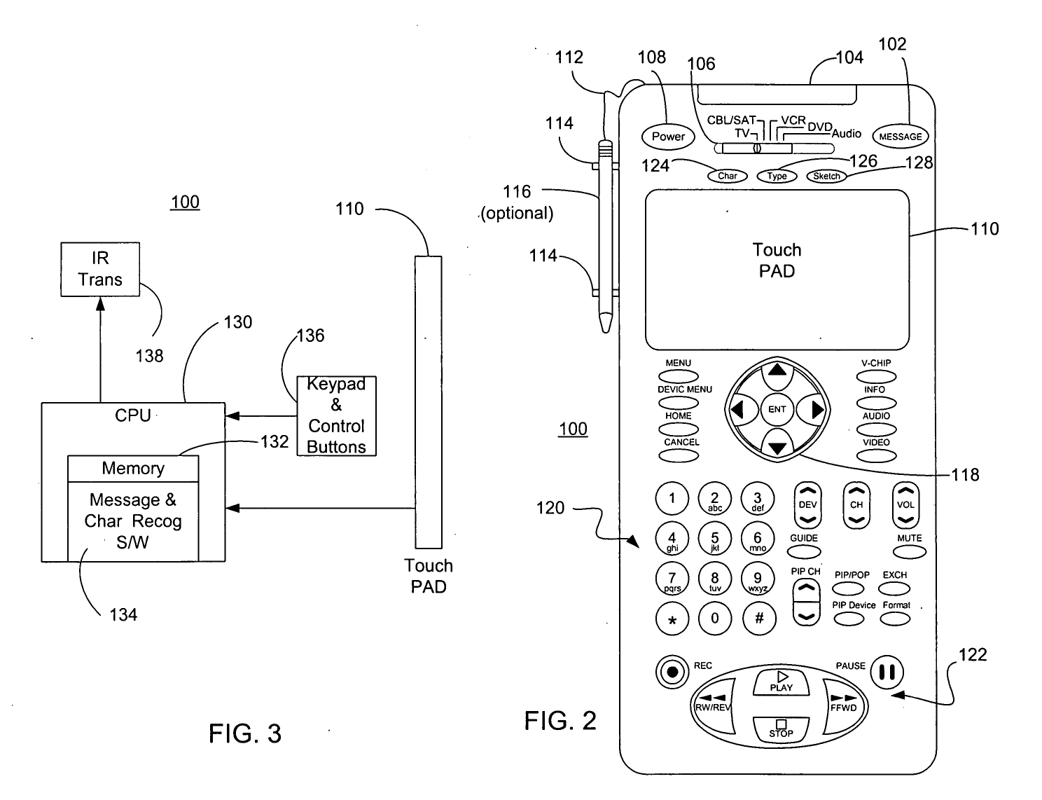

Turning to FIGS. 2 and 3, a remote control 100 is depicted in accordance with the present invention. As shown in FIG. 2, the remote control 100 includes many of the same features, functions, keys and/or buttons as a conventional remote control including, among other things, a power button 108, an IR transmitter window 104, a device slide selector 106, a navigation button 118 with vertical and horizontal cursor and selection entry capabilities, an alpha-numeric keypad 120, and peripheral input device function keys 122, e.g., record, play, fast forward, etc. The navigation button 118 may, in the alternative, be a track ball. In addition to the conventional keys and buttons, the remote control 100 preferably includes a message button 102 to activate the messaging system of the present invention, several messaging input mode keys including cursor 123, character recognition 124, type 126, and sketch 128, a touch sensitive pad area 110, and optionally a stylus 116. In the alternative, the input modes keys may embodied in a single key capable of toggling between the different input modes. The stylus 116 is preferably coupled to the remote 100 with a cord 112 and is retained in an inoperable state on a pair of saddle arms 114. The touch sensitive panel area 110 preferably enables an operator to draft a message or create a sketch by stroking or sketching characters or simple sketches using a stylus, finger or the like.

As shown in FIG. 3, the remote control 100 includes a microprocessor 130 and non-volatile memory 132. Messaging and character recognition software 134 is stored in the non-volatile memory 132 and run on the microprocessor 130. The touch sensitive pad 110 and the keypad and control buttons 136 are operably coupled to the microprocessor 130. An IR transmitter 138, which transmits commands, characters and/or sketches over an IR beam to the TV 20, is also coupled to the microprocessor 130.

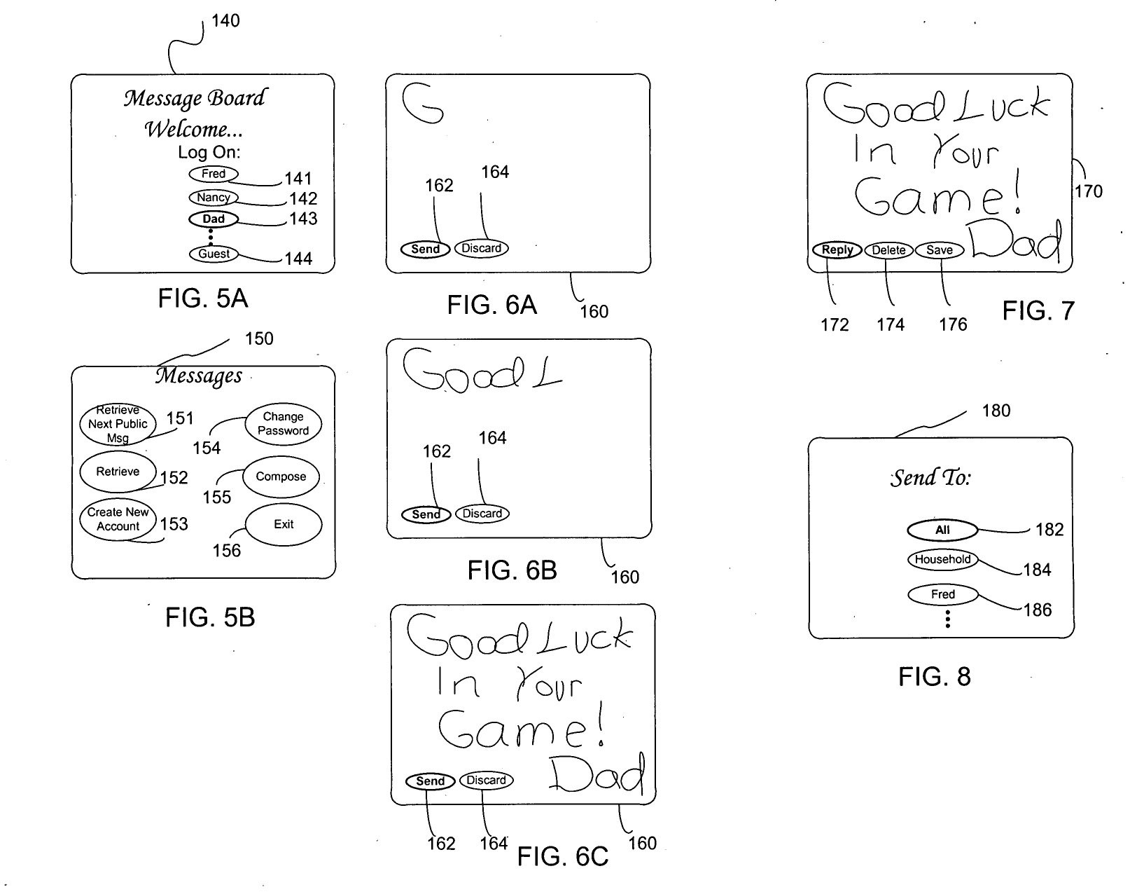

With the messaging system activated by depressing the messaging key 102, the navigation button 118 of the remote control 100 can be used to tab through and select icons appearing on the screen of the TV (see FIGS. 5A-7). Optionally, the navigation button 118 and device function keys 122 could be combined within the touch pad 110. The TV S/W would select a proper mode based on the situation. For example, the operator can toggle between the individual USERS and GUEST icons 142 and 144 on the “Message Board Welcome” screen 140. When the navigation button 118 is depressed the remote control 100 transmits a signal to the TV 20 that is interpreted by the messaging S/W 70 running on the TV's microprocessor 50 to toggle to the next icon on the screen 30. The microprocessor 50 then instructs the OSD control 40 to highlight the next icon on the screen 30. The messaging S/W 70 and OSD control 40 provide a icon based user interface, as depicted in FIGS. 5A-8, to enable the operator to easily navigate through the system 10.

Once at a stage in the messaging process in which a message can be drafted, the remote control 100 can transmit characters and/or sketches over an IR beam to the TV 20 while operating in one of the messaging input modes. In type mode, which is activated by depressing type key 126, the remote control 100 transmits characters entered on the keypad 120. As shown, the alphabet is distributed over number keys 2 through 9 in groups of 3 and 4 letters. The messaging S/W 134 interprets the key strokes on the keypad 120 to determine which character has been inputted. For example, depressing the number 2 key once will be interpreted by the S/W 134 to be the letter “a”, depressing the key twice in close succession will be interpreted by the S/W 134 to be the letter “b”, depressing the key three times in close succession will be interpreted by the S/W 134 to be the letter “c”, and depressing the key four times in close succession will be interpreted by the S/W 134 to be the number “2”. Once the S/W 134 interprets the character entered on the keypad 120, the remote control transmits it to the TV 20 where the OSD control 40 displays it on the screen 20.

In character recognition mode 124, the S/W 134 interprets the characters stroked on the touch sensitive panel area 110. After interactive acceptance of the character, the remote control 100 transmits the character to the TV 20 and the OSD control 40 displays it on the screen 20. A new character can then be generated and transmitted to the TV 20.

In sketch mode 128, the S/W 134 accepts, and the remote control 100 then transmits to the TV 20, a sketch stroked or sketched on the touch sensitive panel area 110 once the stylus 116, finger, or other device used to input the sketch is lifted from the panel 110. Once accepted and transmitted, a new sketch can be generated and transmitted to the TV.

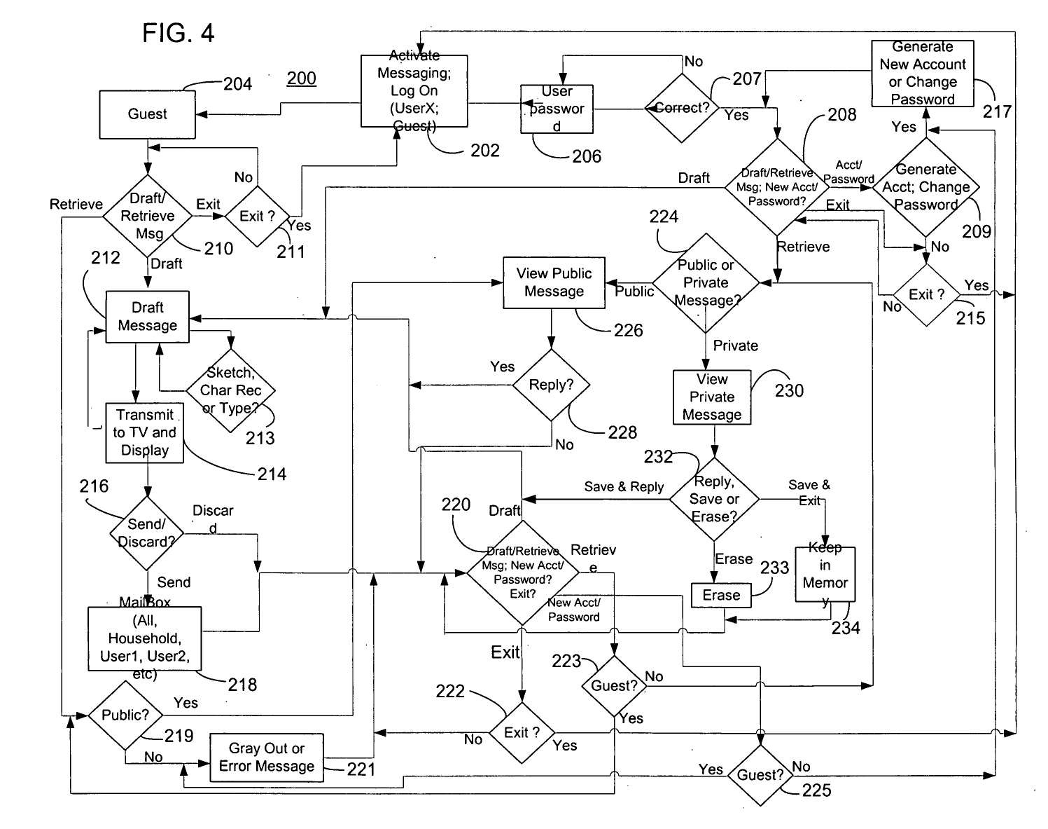

Turning to FIG. 4, a flowchart illustrating the messaging process 200 of present invention is shown. The messaging process 200 is activated at step 202 when the operator depresses the message button 102 on the remote control 100. In response, the remote 100 transmits an “activate the messaging system” signal over an IR beam to the TV 20. The TV's microprocessor 50 interprets the signal and instructs the OSD control 40 to display the “Welcome”/“Log On” screen 140 (FIG. 5A) on the screen 30 of the TV 20. Using the navigation button 118 on the remote 100, the operator toggles between and/or selects one of the “Users”, i.e., Fred 141, Nancy 142, and Dad 143, etc., or “Guest” icons 144, as depicted in FIG. 5A, and, thus, logs on as a guest at step 204 or is asked for password in step 206 which is then compared to passwords stored in memory 70 during a setup process. If the password is correct, the process will continue. The operator is then prompted at step 210, as a guest, to decide whether the operator wants to draft a message or retrieve a “Public” message, or at step 208, as a user, to decide whether the operator wants to generate new user/password, modify password, draft or retrieve a message as shown in FIG. 5B by selecting “retrieve next public message”, “retrieve”, “compose”, “create account” or “change password” icons 151, 152, 153, 154 and 155 on screen 150. If the operator chooses not to draft or retrieve a message at step 210 or generate new user/password, modify password, draft or retrieve a message at step 208, the operator may choose to exit, as shown in FIG. 5B, by selecting an “exit” icon 156, and then at steps 211 or 215 either exit the messaging process 200 or return to steps 208 or 210.

If, at step 208 as a user or at step 210 as a guest, the operator chooses to draft a message, the operator drafts a message at step 212 using one or more input modes to generate characters and sketches which the operator wishes to use to create a message. Preferably, the remote control 100 defaults to one of the input modes, such as “sketch”. The operator, however, can change modes, at step 213, by selecting one of the input mode keys, i.e., character recognition 124, type 128 or sketch 128, prior to or during the message drafting process. As the S/W 134 of the remote control 100 recognizes and accepts individual characters and/or sketches, the characters and sketches are transmitted to the TV 20 and displayed at step 214. FIGS. 6A through 6C show the progression of composing a message from start (FIG. 6A) to finish (FIG. 6C). Steps 212 through 214 are repeated until the operator has completed the desired message and chooses to either “send” or “discard” the message at step 216 by selecting either of the “send” or “discard” icons 162 and 164 displayed on a message composition screen 160 shown in FIGS. 6A through 6C. If at step 216 the operator chooses to send the message, the operator is preferably prompted at step 218 to indicate a mailbox, such as a public mailbox, a household mailbox or a system user, i.e., user 1, user 2, all household members etc., mail box to which the message should be sent as indicated by icons 182, 184 and 186 on screen 180 in FIG. 8. Messages addressed to “all” can be viewed by any operator, guest or User X, while messages addressed to household are private messages for all User X operators. In the alternative, the system 10 could comprise only a single or public mailbox to and from which all messages could be sent and retrieved.

After the completion of step 218 or if at step 216 the operator chooses to discard the message, the operator is prompted at step 220 as to whether the operator wishes to draft a new message or exit, or if the operator is a system user, retrieve a new message or setup a new account, or modify password. If the operator chooses to draft a new message, steps 212 through 216 are repeated. If the operator chooses to exit at step 220, the operator is prompted at step 222 as to whether the operator wishes to exit the messaging process 200 or return to step 220.

If at step 208 or at step 220 the operator as a system user chooses to retrieve a message, the User X is prompted at step 224 as to whether the operator wishes to retrieve public or private messages. If at step 224 the User X chooses to retrieve public messages, the OSD control 40 causes a first message stored in a public mailbox to displayed on the screen 30 for the operator to view at step 226. The operator is then prompted whether to reply to the message at step 228. If yes, steps 212 through 216 are repeated. If at step 228 the operator choose not to reply, the operator is then prompted at step 220 as to whether the operator wishes to retrieve or draft a new message, or setup a new account, if logged on as User X, or exit. If the operator chooses to draft a new message, steps 212 through 216 are repeated and if the operator chooses to retrieve a new message, the operator is queried at step 223 as to whether the operator is logged on as a user or guest. If logged on as a User X, the operator is returned to step 224. A guest is limited to “Public messages”. If logged on as a guest, and the operator chooses to retrieve a message at steps 220 or 210, the operator is prompted at step 219 whether to retrieve a public message. If yes, a first public message is viewed at step 226. If no, an error message is received at step 222 and then the operator is prompted again at step 220 as to whether to retrieve or draft a message, etc. If at step 220 the operator chooses to exit, the operator is prompted at step 222 whether to exit the messaging system or return to step 220.

If at step 224 the operator chooses to view private messages, the OSD control 40 causes a first message stored in the operator's user mailbox to displayed on the screen 30 for the operator to view at step 230. Alternatively, the operator can tab through the stored messages and select a message desired for viewing using the navigation button 118 on the remote 100. As shown in FIG. 7, the operator can then choose at step 232 whether to reply to, save or erase the message by selecting one of the “reply”, “save” or “erase” icons 172, 174 and 176 appearing on the message display screen 170. If the operator chooses to reply to the message, steps 212 through 216 are repeated. If the operator chooses to save the message, the message remains stored in memory at step 234. After the message is stored or if at step 232 the operator chooses to erase the message, the operator is then prompted at step 220 whether to draft or retrieve a new message, or setup a “New Account” (if User X) (FIG. 5B) or “modify by password” If the User X chooses to draft a new message, steps 212 through 216 are repeated and if the operator chooses to retrieve a new message, the operator is returned to step 224. If guest chooses “Public message” retrieval, he will proceed to step 226. If at step 220 the operator chooses to exit, the operator is prompted at step 222 whether to exit the messaging system or return to step 220.

If the at step 222 the operator chooses to exit the messaging system 10, the OSD control 40 causes the message board to be withdrawn from the screen 30 of the TV 20 and a video image to be displayed on the screen 30.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

1. A messaging system comprising
a display device having control system and an input signal sensor, and
a remote control device operably couplable to the input signal sensor, the remote control device including a touch sensitive pad area and a signal transmitter,
wherein the control system causes messages contained in input signals received from the remote control device to be displayed on an display screen.

2. The message system of claim 1 wherein the control system is manipulatable to cause the messages to be sent to a system mailbox.

3. The message system of claim 1 wherein the control system is manipulatable to cause the messages to be erased.

4. The message system of claim 1 wherein the control system is manipulatable to cause the messages to be replied.

5. The message system of claim 1 wherein the display device is a television.

6. The message system of claim 1 wherein the control system includes a central processing unit (CPU) and an on screen display control coupled to the CPU and the display screen.

7. The message system of claim 6 wherein the CPU includes nonvolatile memory.

8. The message system of claim 7 further comprising messaging software stored in the nonvolatile memory and running on the CPU.

9. The message system of claim 1 wherein the remote control includes a message button to activate the message system.

10. The message system of claim 1 wherein the remote control includes a plurality of input mode keys.

11. The message system of claim 1 wherein the remote control includes an input mode key togglable between a plurality of input modes.

12. The message system of claim 1 wherein the remote control includes a stylus.

13. The message system of claim 1 wherein the remote control includes a microprocessor.

14. The message system of claim 13 wherein the remote control includes nonvolatile memory.

15. The message system of claim 14 wherein the remote control includes character recognition software stored in the nonvolatile memory and running on the microprocessor.

16. A remote control device comprising
a microprocessor,
a touch sensitive pad area coupled to the microprocessor,
a signal transmitter coupled to the microprocessor,
nonvolatile memory coupled to the microprocessor, and
character recognition software store in the nonvolatile memory and running on the microprocessor.

17. The message system of claim 16 wherein the remote control includes a message button to activate a message system.

18. The message system of claim 16 wherein the remote control includes a plurality of input mode keys.

19. The message system of claim 16 wherein the remote control includes an input mode key togglable between a plurality of input modes.

20. The message system of claim 16 wherein the remote control includes a stylus.
